(19) United States
(12) Patent Application Publication
(10) Pub. No.: US 2002/0044655 A1
(43) Pub. Date: Apr. 18, 2002

(54) Information appliance and use of same in distributed productivity environments

(76) Inventor: David C. Applebaum, Columbus, OH (US)

Correspondence Address: Killworth, Gottman, Hagan & Schaeff, L.L.P., Suite 500, One Dayton Centre, Dayton, OH, 45402-2023, US

(21) Appl. No.: 09/981,410

(22) Filed: Oct. 17, 2001

Related U.S. Application Data
(60) Provisional application No. 60/241,523, filed on Oct. 18, 2000.

(51) Int. Cl. H04L 9/00

(52) U.S. Cl. 380/45

(57) ABSTRACT

A method of storing information on an information appliance comprises organizing individual information contexts, each of which are intended to be used by different applications, as segments within a single linear sequence or string where the different segments are delimited by known bit patterns or by different encoded representations. Reading from and writing to the string can be carried out within the information appliance itself, by a client application operating between the information appliance and a network such as the Internet, or by a remote host performing data exchange with the information appliance over the network. The present invention is also useful in accomplishing security, authentication and identification tasks. In these applications, biometric or other security data including secret/personal information such as pass codes and personal identification numbers or certificates are stored in the string. The security data is accessible by applications to verify the authenticity of the identified user.

### CROSS REFERENCE TO RELATED APPLICATIONS

This application claims the benefit of U.S. Provisional Application No. 60/241,523 filed Oct. 18, 2000, which is incorporated herein by reference.

### BACKGROUND OF THE INVENTION

The present invention relates in general to information appliances, and in particular to systems and methods for adding or removing programs and data to the information appliance without having to reprogram the file or data structure therein. The present invention further relates to the secure implementation of such information appliances in distributed productivity environments.

Information appliances are playing an ever increasing role in the day-to-day transactions of commercial and consumer activities. For example, information appliances in the form of smart cards are appearing more common in the debit and credit industries. Personal digital assistants (PDA's), cell phones, and other hand held portable devices now offer access to the Internet to send and retrieve messages, perform financial and other transactions, and store and retrieve data. Also, information appliances embedded in form factor items such as refrigerators and ovens are becoming more readily available that communicate over the Internet to place their own service calls, download recipes, and perform other intelligent functions.

In current practice, information contexts including data, programs, and other information are stored on information appliances and other binary devices as a sequence of bits. For organizational and other reasons, each particular information context is stored as a discrete file. As such, a given device manages multiple information contexts by managing a number of discrete files.

Typically, the necessary files are programmed into information appliances prior to distribution of the information appliance to the intended recipient. However, it often occurs that new applications, features, or functions are desired to be added after an information appliance has been distributed. In order to implement the new and desirous changes, the file structure of the information appliance must be modified or reprogrammed. This modification frequently requires that all information appliances in the field are recalled and replaced with new versions containing the additional functionality. Unfortunately, recall and reissue campaigns are time consuming and costly.

In addition to the technical challenge of implementing file structures on information appliances, consumer confidence in using the product must be earned. That is, in order for information appliances to gain wide acceptance, users must believe that the information being exchanged through the information appliance is accurate, secure, and transacted between legitimate parties. Therefore, identification, authentication, security, and information validity issues must be addressed in electronic transaction systems that incorporate information appliances. For example, in telemedicine and telehealth applications, there is a strong need to protect the substance and character of transactions between the patient and care-provider. These issues are important for patient-care-giver trust and, in some cases, may be subject to regulatory environments including the uniform reporting requirements of HIPAA. Because of the remote access character of such processes, technologies and processes are needed to positively identify and authenticate the patient and health-care individuals involved in telemedicine and telehealth transactions. The need for security, authentication and identification are not limited to telemedicine and telehealth applications. Rather, there are a number of existing and emerging applications that require security, authentication, and identification.

Accordingly, there is a need for systems and methods of storing programs and information on information appliances including smart cards, that eliminates the need for an independent file structure for each individual information context. Further, there is a need for an information appliance that allows new programs and information to be added, and existing programs or data to be edited or subtracted without having to reprogram the structure on the information appliance. Still additionally, there is a need for an information appliance that can transact securely in a distributed productivity environment, and that provides a convenient and effective manner of identifying and authenticating users.

### SUMMARY OF THE INVENTION

The present invention overcomes the disadvantages of previously known information appliances by organizing individual information contexts as segments within a single linear sequence or string where the different segments are delimited by known bit patterns or by different encoded representations. Each segment may include for example, information contexts intended for different applications. Accordingly, the information appliance is required to manage only a single string for all information contexts used thereby, regardless of the number of information contexts including applications and data stored therein. The storage of multiple and discrete data and programs as segments within a single file provides a highly portable system useful in the exchange of information between information appliances, such as smart cards, remotely, through the Internet. In this configuration, the implementation of reading from and writing to the string can be carried out within the information appliance itself, by a client application operating between the information appliance and a network such as the Internet, or by a remote host performing data exchange with the information appliance over the network.

In applications involving distributed productivity environments utilizing the Internet or other network, the present invention is also useful in accomplishing security, authentication and identification tasks. In these applications, biometric or other security data including secret/personal information such as passcodes, personal identification numbers, and certificates are stored in the string. The security data is accessible by applications to verify the authenticity of the identified user. Further, encryption methods using symmetric and asymmetric keys provide a mechanism for securing data stored on the information appliance.

Accordingly, it is an object of the present invention to provide systems and methods of storing programs and information on information appliances including smart cards that eliminates the need for an independent file structure for each individual information context.

It is an object of the present invention to provide an information appliance that allows new programs and information to be added, and existing programs or data to be edited or subtracted from the system without having to reprogram the structure on the information appliance.

It is an object of the present invention to provide an information appliance that can transact securely in a distributed productivity environment, and that provides a convenient and effective manner of identifying and authenticating users.

Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals, and in which:

FIG. 1 is a schematic illustration of a structure for storing different information contexts as delimited segments in a single string according to one embodiment of the present invention;

FIG. 2 is a schematic illustration of the structure of FIG. 1, where a select one of the segments is removed from the string, processed, then returned to the string in the same relative position, according to one embodiment of the present invention;

FIG. 3 is a schematic illustration of a structure for storing different information contexts as delimited segments in a single string where each delimiter is unique according to another embodiment of the present invention;

FIG. 4 is a schematic illustration of the structure of FIG. 3, where a select one of the segments is removed from the string, processed, then returned to the string by appending the removed segment to the end of the string;

FIG. 5 is a flow diagram illustrating a typical operation where the contents of the string are read but not changed according to one embodiment of the present invention;

FIG. 6 is a flow diagram illustrating a typical read, process, and write operation according to one embodiment of the present invention;

FIG. 7 is a schematic illustration of a first encrypting scheme according to one embodiment of the present invention, where a unique encryption process encrypts each segment of the string separately;

FIG. 8 is a schematic illustration of a typical decryption process for decrypting the encrypted string of FIG. 7 according to one embodiment of the present invention;

FIG. 9 is a schematic illustration of a typical encryption and decryption process according to another embodiment of the present invention;

FIG. 10 is an illustration of an information appliance implemented as a smart card connectable to a distributed productivity environment according to one embodiment of the present invention; and,

FIG. 11 is an illustration of a plurality of information appliances communicating across a distributed productivity environment according to one embodiment of the present invention.

### DETAILED DESCRIPTION OF THE PREFERRED EMBODIMENTS

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that logical changes may be made without departing from the spirit and scope of the present invention.

### The Information Appliance

The present invention is directed to information appliances and the use of information appliances across distributed productivity environments. Information appliances can be embodied in a number of forms ranging from simple memory devices to computer-controlled devices. For example, information appliances may include contact and contactless smart cards including memory and microprocessor based smart cards, secure portable tokens, hand held devices such as Personal Digital Assistants (PDA), internet phones, electronics integrated into established form factor items such as VCRs, televisions, and kitchen appliances, intelligent sensors, actuators, RFID devices, any digital electronics that provide consumer-focused access to the features and benefits of the Internet, and other formatted binary storage devices.

### Information Appliance File Structure

One aspect of the present invention comprises methods and techniques for loading and storing programs and data on information appliances. In a typical information appliance, each distinct information context is stored as a separate file. Each file comprises a collection of related data, program, records, or other information stored as a unit with a single name. A file can include any number of different file types including for example, data files, text files, program files, and directory files. However, the present invention provides a unique file structure wherein data and programs for multiple and diverse applications are stored on information appliances as a single delimited string.

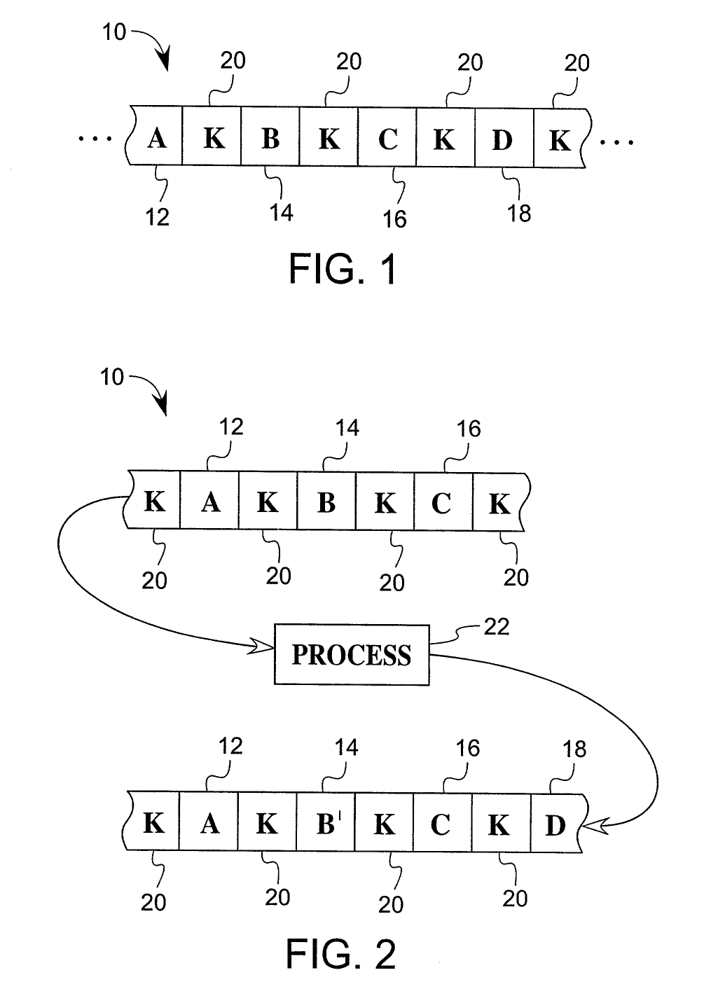

Referring generally to FIGS. 1 through 11, various exemplary techniques are illustrated for storing information including data and programs on an information appliance such that multiple applications can be saved as a single string. This unique approach to storing data facilitates the selective performance one or more different applications. More particularly, data and applications can be added, removed, or edited without the need to reprogram the information appliance.

Referring to FIG. 1, a single string 10 is stored in a memory area of an information appliance. The string 10 is comprised of a plurality of segments 12, 14, 16, and 18. As shown, segment 12 comprises information context “A”, segment 14 comprises information context “B”, segment 16 comprises information context “C”, and segment 18 comprises information context “D”. The segments 12, 14, 16, and 18 are data, programs, or other information, intended for use by different applications. For example, segment 12 may comprise biometric information for an authentication program. Segment 14 may comprise data used by an epurse program. Segment 16 may comprise information and data for a credit provider's application, and segment 18 may comprise program for performing certain administrative functions. As such, the type of stored information will depend upon the nature of the application to which the segment is associated. Interleaved between each of the segments 12, 14, 16, 18 are delimiters or segment identifier 20 (represented by the symbol K).

The segment identifiers 20 are known bit patterns or encoded representations that provide bounds to the individual segments 12, 14, 16, and 18. In this manner, a specific segment containing programs or data for a particular application or function of the information appliance can be recovered and accessed through the detection and removal of the segment identifiers 20. It will be appreciated that each of the segments 12, 14, 16, and 18 are stored as separate files in conventional practice. In contrast, according to the present invention, a single string is comprised of one or more delimited segments where each of the delimited segments comprises a delimiter or segment identifier 20, and a segment. It will be appreciated that the number of segments in a given string 10 can vary depending upon the number of different applications to be accommodated by the information appliance. Further, the string 10 may be embodied in a number of ways including for example, a linear sequence, file or string.

An example of a technique for recovering a predetermined one of the segments 12, 14, 16, and 18 is illustrated in FIG. 2. To recover information context B stored in segment 14, the string 10 is serially read out, and the delimiting patterns K of the segment identifiers 20 are detected and removed until segment 14 (information B) is recovered. As illustrated, the segment identifiers 20 are identical (represented as delimiting pattern K) throughout the string 10. Accordingly, to recover the segment 14, the position of the segment 14 within the string 10 must be known. Once recovered, the segment 14 is processed as required by its associated application 22. If segment 14 is to be removed from the information appliance, the string is saved back to the information appliance without segment 14.

To store the edited information B′ back to the information appliance, the segment 14 containing edited information B′ must be returned to the same position within the string 10 such that the order of the segments is preserved. Likewise, the associated application 22 may be used to add a new segment. As shown, the original string 10 comprises segments 12, 14, 16. To add a new segment 18, the segment 18 is concatenated with a segment identifier 20 and is appended to the end of the string 10. The relative position of the new segment 18 within the string 10 is recorded, and the string is written back to the information appliance.

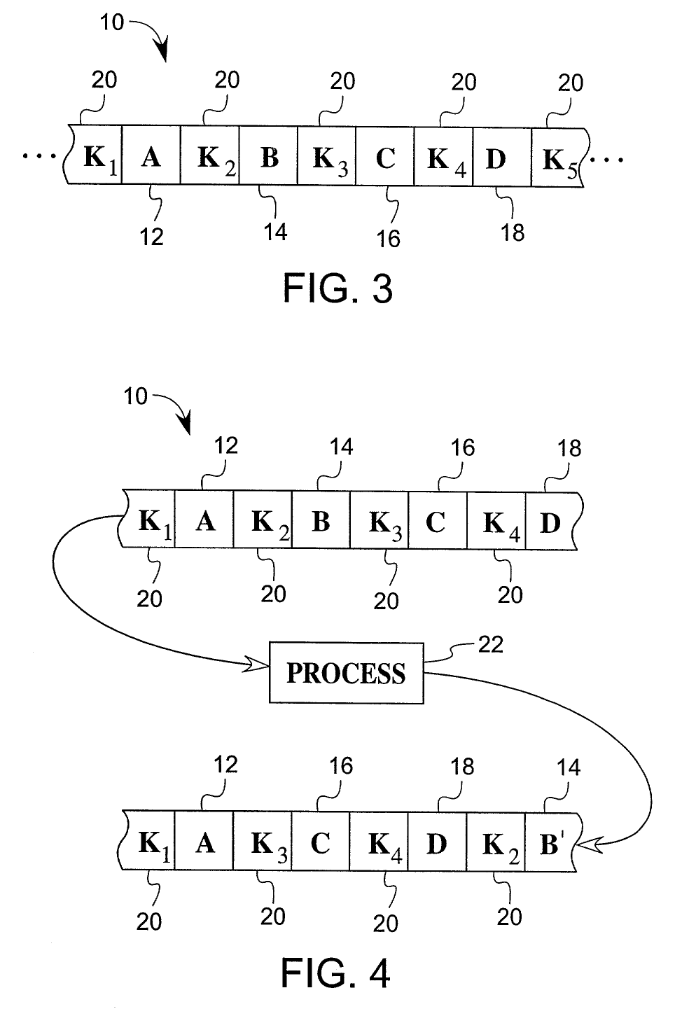

Referring to FIG. 3, another embodiment of the present invention is illustrated where each segment identifier 20 in the string 10 has a unique delimiting bit pattern. As such, the serial access methods described above with reference to FIG. 2 may optionally be replaced with random access methods. For example, the segment identifier 20 that precedes segment 14 contains the unique delimiting pattern K2. Referring to FIG. 4, to recover the segment 14, the string 10 is searched for the segment identifier 20 containing the delimiting bit pattern K2. The segment identifier 20 containing delimiting bit pattern K2 is stripped off, and information context B contained in segment 14 is read out. The information context B is manipulated by its associated application 22, rendering information context B′. The segment identifier 20 containing the delimiting bit pattern K2 is then written back out along with segment 14 (containing new information context B′). Because the segment identifier 20 is written out with the segment 14, the exact positioning of the segment 14 within the string 10 need not be preserved. For example, as illustrated, the segment 14 is moved to the end of the string 10.

According to one embodiment of the present invention, the length of each segment 12, 14, 16, and 18 is recorded in the string. This allows the information appliance to recover the entire segment after locating a single segment identifier 20. Under this arrangement, the desired segment identifier 20 (predetermined delimiter) is located within the string 10. Next, the segment length is read out to determine the length of the desired or predetermined segment. For example, the segment length is encoded in one or more bytes in a first portion adjacent to the predetermined delimiter. Subsequently, the segment is read out.

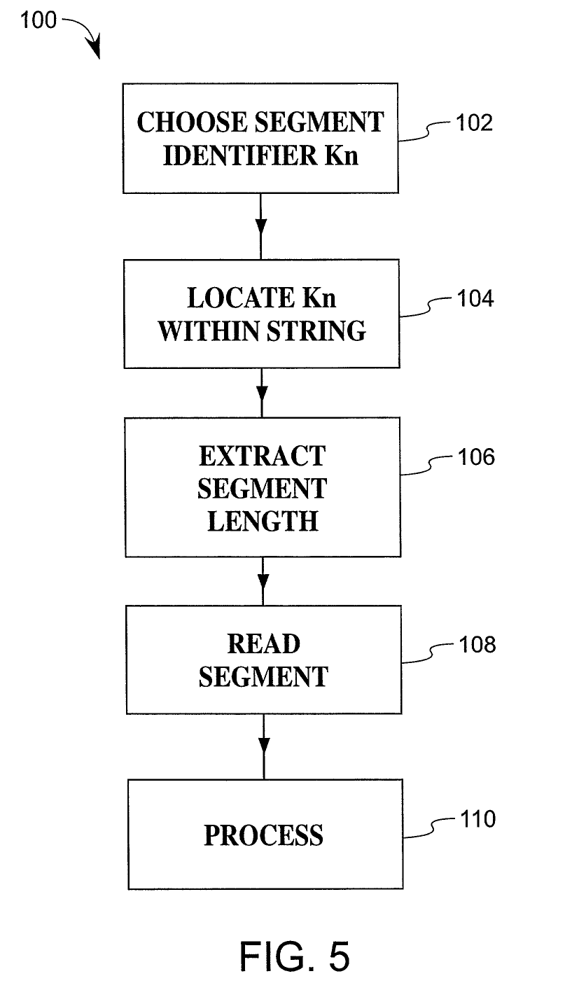

In certain applications, a select one of the segments 12, 14, 16, and 18 is read but not altered. For example, in certain biometric applications, data from a reader such as a finger print reader is compared to predetermined finger print data. Under this arrangement, no data will be written to the string 10. Referring to FIG. 5, a typical read operation flow 100 is illustrated. The segment identifier that corresponds to the segment of interest is chosen (see 102). The string is then searched to locate the requested segment identifier within the string (see 104). Once the segment has been located, the segment length is extracted (see 106). For example, the segment length can be stored as the first byte or bytes immediately following the segment identifier. Based upon the known segment length, the segment is then read out of the string (see 108) and the application associated with the recovered segment processes the segment as the application dictates (see 110).

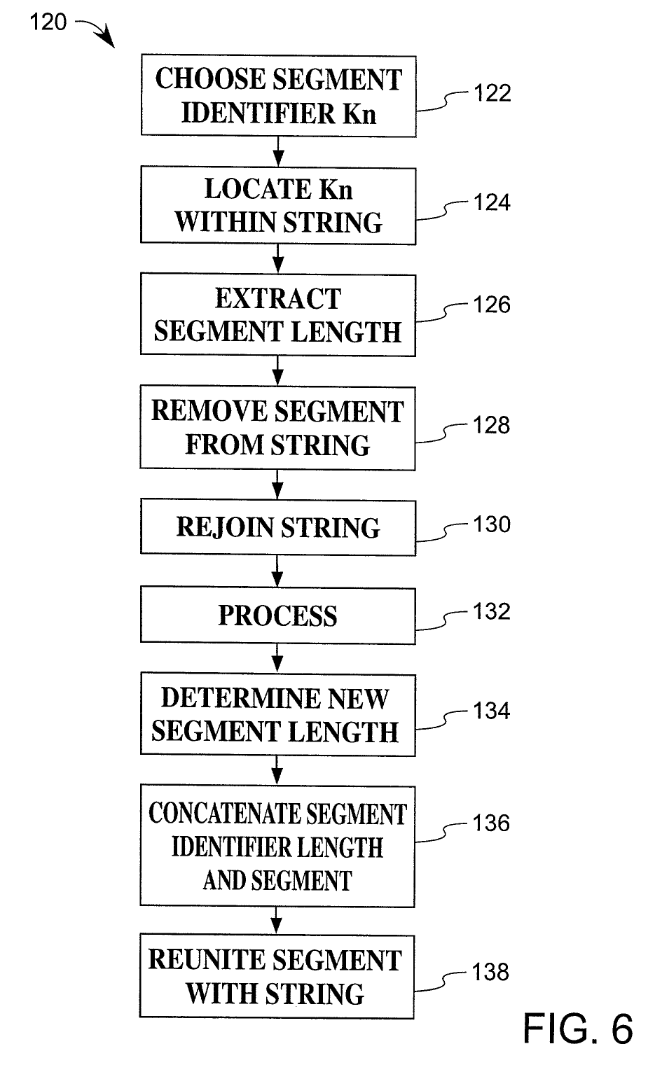

Referring to FIG. 6, a typical operation involving a string read and write cycle 120 is illustrated. The segment identifier that corresponds to the segment of interest is selected (see 122). The string is then searched to locate the requested segment identifier within the string (see 124). Once the segment has been located, the segment length is extracted (see 126). Based upon the known segment length, the segment is then removed from the string (see 128). Further, the segment identifier is stripped out. The string is then joined together (see 130) without the removed segment and segment identifier. The requesting application processes the segment (see 132). The processing of the segment can involve editing the segment contents, making additions and/or deletions. When the application has completed processing the segment, the new length of the segment is determined (see 134). The segment identifier, the determined length of the segment, and the segment are then concatenated (see 136) and reunited with the string (see 138). As discussed more thoroughly above, depending upon the implementation of the segment identifiers, the edited data portion may be placed back in the same relative position from which it came, it can be appended either to the beginning or end of the string, or rejoined to the string after any segment.

The ability to concatenate segment identifiers and segments to the string further allows the addition of new delimiters and segments, and the removal of old or unused segment identifiers and segments from the string. For example, an upgrade application can engage in a transactional session with an information appliance to remove old segments and their associated segment identifiers, and new segments and associated segment identifiers that did not exist previously can be added to the string, by appending the new segments to the end of the string. These transactions may be accomplished in the background either with or without the customer's knowledge.

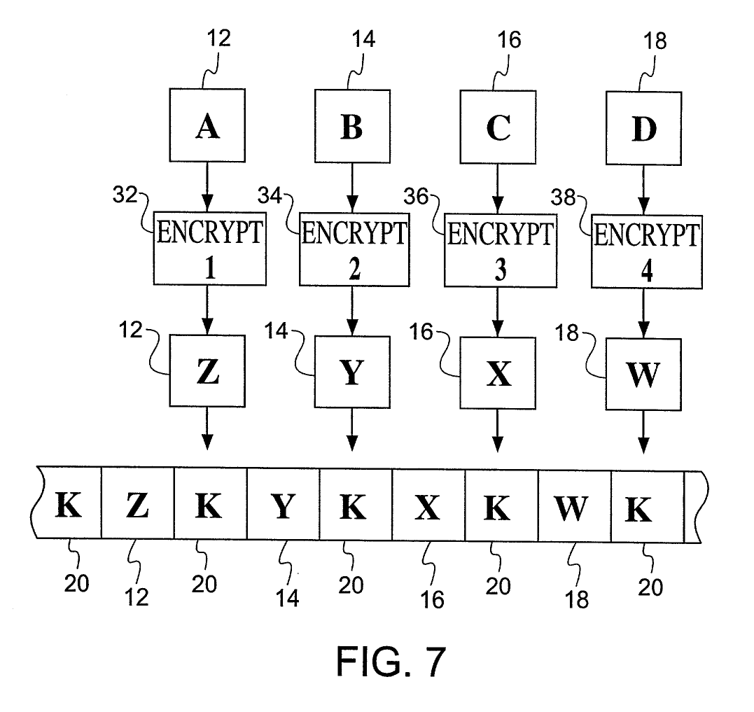

It will be appreciated that other techniques can be used within the present invention. For example, the information appliance can access a select one of the segments by locating a first delimiter and reading until a second delimiter is encountered. Under such a construction, the string need not include each segments length. Further, the exact implementation of the string will depend upon factors such as the information appliance operating system. For example, the flexible structure of the present invention allows the string, or linear sequence of delimited segments to be dropped into a file structure in the case of MPCOS and MULTOS, an object structure in the case of JAVA. Further, the string is easily adapted to other device operating systems, or any other storage format implemented by the information appliance.

Where security is an issue, the various embodiments of the present invention may be practiced with encryption techniques, including for example, the use of symmetric and asymmetric keys. Referring to FIG. 7, a security scheme according to one embodiment of the present invention is illustrated. Segment 12 containing information context A is encoded using encryption routine 32. The encryption routine 32 is unique to the segment 12 and encrypts information context A to unintelligible information Z. Information context B in segment 14 is encoded by encryption routine 34 to render unintelligible information Y. Information context C in segment 16 is encoded by encryption routine 36 to render unintelligible information X. Information context D in segment 18 is encoded by encryption routine 38 to render unintelligible information W. The string 10 is then formed such that the segments 12, 14, 16, and 18 are stored as encoded unintelligible information Z, Y, X, and W, and is unintelligible if read. Because each segment 12, 14, 16, and 18 is encoded with a unique encryption routine 32, 34, 36, and 38, any single decoder will be unable to render multiple segments intelligible.

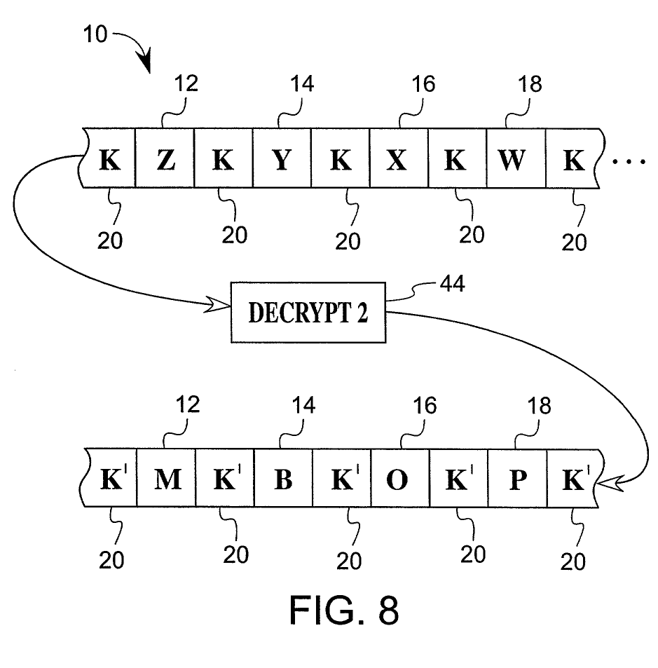

For example, referring to FIG. 8, where an application requires information from segment 14, a decryption routine 44 is used to process the string 10. The decryption routine 44 must be complimentary or otherwise compatible with the encryption routine 34 in order to render the segment 14 intelligible. The segment 12 containing information context A was encoded using encryption routine 32, which is not compatible with the decryption routine 44, thus segment 12 is decrypted to unintelligible information M. Because the decryption routine 44 is compatible with the encryption routine 34, the segment is successfully decrypted from encoded unintelligible information Y to the correct information context B. Segment 16 is decoded by the decryption routine 44 as unintelligible information O, and segment 18 is decoded by the decryption routine 44 as unintelligible information P. It will be appreciated that the serial or random access methods discussed above, using the same or unique bit patterns for the segment identifiers 20 may be practiced with this embodiment of the present invention to locate segment 14 after decrypting the string 10.

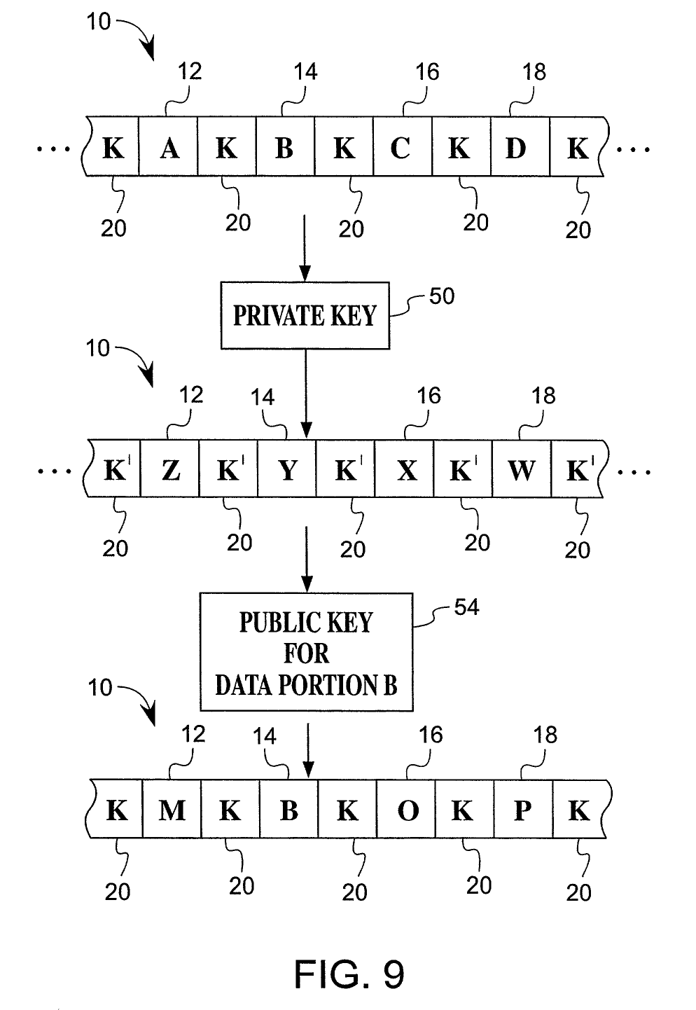

Referring to FIG. 9, a system using asymmetric keys according to one embodiment of the present invention is illustrated. Asymmetric keys are comprised of a key pair, including a first key and a second key. The first and second keys perform inverse functions such that a message encrypted by the first key can be decrypted by the second key, and vise-versa. The entire information file 10 is encrypted using a private key or first key 50 and stored within the information appliance (Not shown in FIG. 9) in an encoded fashion. As illustrated, information context A is encoded to unintelligible information Z, information context B is encoded to unintelligible information Y, information context C is encoded to unintelligible information X, and information context D is encoded to unintelligible information W. Assume an application or information appliance function requires the contents of segment 14. That application or function is provided with a public key or second key 54 that is capable of deciphering only that data contained within the segment 14. As such, decoding the application file 10 with the public key 54 yields unintelligible information M in the segment 12, the proper information context B in the segment 14, unintelligible information O in the segment C, and unintelligible information P in the segment 18. It will be appreciated that the serial or random access methods discussed above, using the same or unique bit patterns for the segment identifiers 20 may be practiced with this embodiment of the present invention to recover segment 14. Further, the roles of the private and public keys may be reversed, and alternatively, other encryption schemes may be used, including for example, symmetric key encryption.

A number of different security schemes may be implemented with the various embodiments of the present invention. This is especially true where the information appliance comprises a central processing unit. For example, the processor may be programmed to prevent data writes and reads unless some access parameter is achieved. According to one embodiment of the present invention, the information appliance comprises a session key. The session key is used to manage the threat of disclosure by hacking of an individual smart appliance. Basically, the string or linear sequence containing the delimited segments is encrypted using a one-time session key. The one-time session key is separately encrypted and stored in an accessible location, either within the information appliance, or a separate computer, and is used to unencrypt the string for processing.

It will be appreciated that while symmetric and asymmetric encoding are preferable, other forms of data security and encryption may be used. The application and security needs dictate the appropriate encryption schemes. According to one embodiment, a random seed is regenerated for each session writing to the information appliance. As such, a potential fraud perpetrator that gains access to the session key only potentially exposes the current content of the segments within the string 10, and not a subsequently encoded string 10.

Further, additional safeguards can be built into the smart appliance system to ensure that the content of segments are not corrupted. For example, redundant verification of the segments can be used to determine errors in returning the string. According to one embodiment of the present invention, redundant verification of the segment length is implemented. Further, appending edited segments to the end of the string instead of reinserting them back into their original location is known to reduce the chance of error when saving the string back to the information appliance.

It will further be appreciated that the present invention, including the above-described examples is portable, and can be applied to virtually any information appliance. The present invention is further advantageous in that an identification and authentication architecture is provided that does not rely on any proprietary or customized hardware devices. Further, because of the self-organizing arrangement of this data string, the string can be stored and retrieved over one or multiple files in order to accommodate its size. This characteristic allows the method to be used with any smart card storage scheme independent of the vendor.

### Distributed Productivity Environments

Information appliances according to the present invention, can be effectively leveraged in distributed productivity environments. Some information appliances such as those integrated with form factor devices including for example, web televisions, refrigerators and other household appliances may have an interface built in. However, generally, for portable information appliances such as smart cards, an appropriate reader or interface is required. The reader optionally supplies power to the information appliance, and provides an interface through which the information appliance can transact with other processes. The type of interface or reader will depend upon the embodiment of the information appliance, and thus will be generally referred to herein as peripheral interface device.

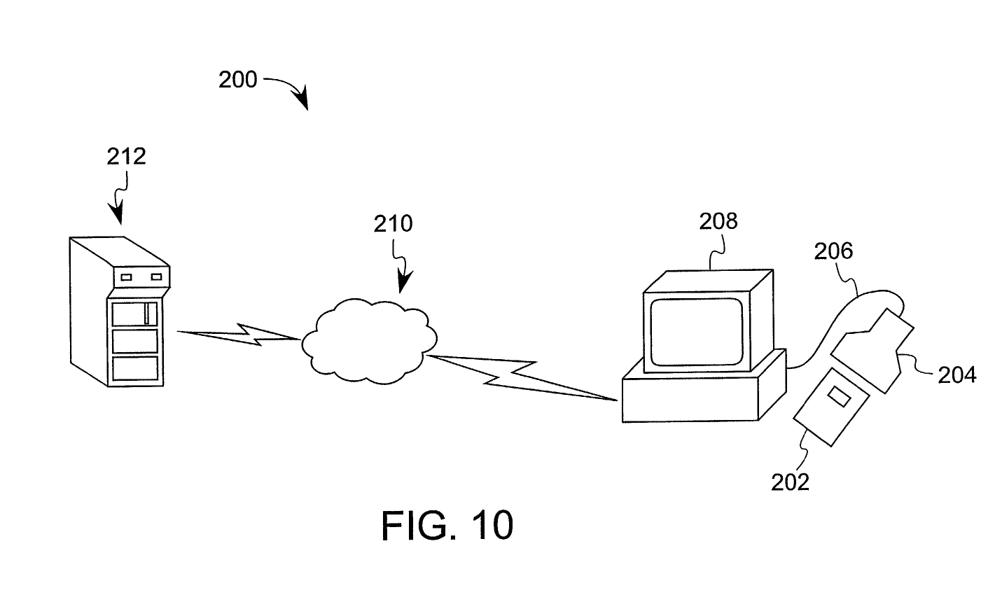

Referring to FIG. 10, a distributed system 200 comprises an information appliance 202, a smart card as illustrated, that is insertable into a peripheral interface device 204. The peripheral interface device 204 comprises a smart card reader, however, the type of peripheral interface device used, if one is even required, will depend upon the type of information appliance being interface. The peripheral interface device 204 communicates over a first communications link 206 to a first computer 208. The first communications link may comprise a direct cable connection, a network connection, a wired or wireless connection, or any other communications link. For example, the peripheral interface 204 may have a built in modem, network interface or other communications interface that allows communication between the information appliance 202 and the first computer 208 over any network, including for example, the Internet. The first computer 208 may comprise a personal computer, network computer, World Wide Web server, or any other computer, depending upon the intended application.

According to one embodiment of the present invention, the first computer 208 comprises a personal computer that communicates over a second communications link 210 to a second computer 212. The second communications link can be any wired or wireless connection to the Internet. The second computer 212 is comprises a server running Internet enabled software. Under this arrangement, processing of information stored on the information appliance 202 including cryptographic, authenticating and identifying tasks can be carried out on the information appliance itself, on the first computer 208, on the second computer or server 212, or any combination thereof. This flexibility allows the information appliance 202 to be compatible with virtual private networks, third party certificates, and other network security schemes, and additionally allows the information appliance to work with electronic commerce applications such as the Electronic Data Interchange platform. Preferably, the information appliance interfaces with a web browser running on the first computer 208, and the web browser on the first computer 208 communicates with web enabled applications on the server or second computer 212.

### Information Appliance Security Systems

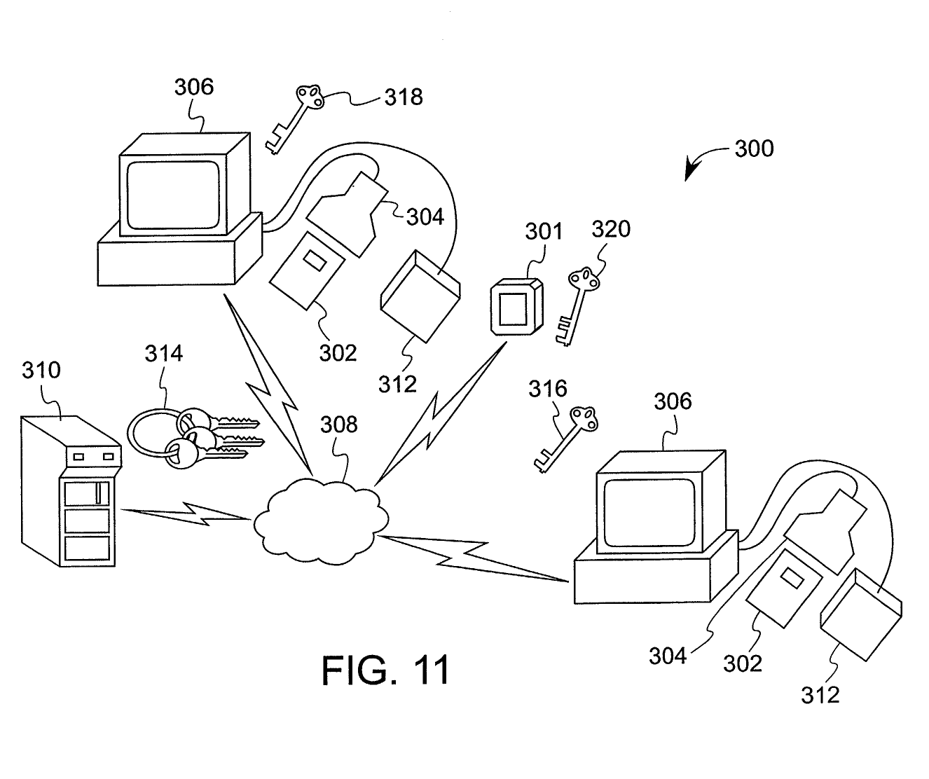

Referring to FIG. 11, a secure transaction system 300 is arranged to provide secure and unambiguous information appliance transactions. To initiate a secure transaction, at least one information appliance forms a networked connection. For example, portable information appliances 301 such as the personal digital assistant or wireless hand set may have a built wired or wireless interface that allows a network connection to be established. An information appliance in the form of a smart card 302 is inserted into an appropriately configured peripheral device interface or smart card reader 304. The peripheral interface device 304 allows the information appliance 302 to communicate with a personal computer 306. The various devices including the personal computer 306 and portable information appliance 301 communicate over a network connection 308 to a server 310. The server 310 is arranged to confirm the identity of a party logged into the server 310 by validating information obtained from the information appliance.

The information appliances 301, 302 utilize a file structure comprising a string of delimited segments according to the present invention. At least one segment of the string is configured to store identifying information. For example, one or more segments may contain biometric information such as data relating to a fingerprint, eye scan, face recognition, voice pattern, DNA sequence, or any other biometric feature.

Each computer 306 is further coupled to a biometrics interface device 312. The biometrics interface device 312 is arranged to read biometric information from the user. The system 300 reads biometric information from the biometrics interface device 312 and compares that data to biometric data stored within the information appliance 302. Under this arrangement, the information appliance 302 actually verifies the identity of the user. Once the identity of the user is verified by the information appliance 302, the information appliance 302 can communicate with the computer 306 and the server 310. Further, because a verified user has been properly authenticated, a coded, ambiguous, or otherwise disguised identity can be used in communications across the network to protect the privacy of the user. Accordingly, the user maintains possession and control over their own identifying and personal information, and that information is not broadcasted over any network.

As an alternative to biometric information, authenticating information may be stored on the information appliance in the form of a code such as personal identification number (PIN). In this case, a separate biometrics interface device 312 is not necessary. Rather, the user can enter their PIN in on a keyboard or other input/output device. Alternatively, a password or other similar passcode may be used to identify the user. For example, the portable information appliance 301 implemented as a PDA or Internet phone already includes a simple keypad. As such, the identity of the user can be determined by requiring a user to enter an appropriate passcode.

Other security measures may be integrated into the secure transaction system 300 to provide authentication that the portable information appliance 301, 302 being used is not counterfeit. This is accomplished through asymmetric cryptographic key/message exchanges and verifications between the various wired and wireless networks and the portable information appliances 301, 302. For example, the string stored on the portable information appliance 301, 302 can be encrypted using any encryption techniques, including those described more fully herein. In a preferable security scheme, strings stored on each of the portable information appliances 301, 302 are encoded using a private key held by the server 310. A unique public key 316, 318, 320 is then provided to each user.

Further, various certificate schemes may be used. For example, ISO X.509 compliant digital certificates can be issued to each of the portable information appliances 301, 302. Under this arrangement, a certificate issuer provides encrypted delivery of an encryption key belonging to one of the transaction organizations. Inherent in the delivery is the authentication through the certifying organization of the identity of the key's owner.

By a providing encryption schemes, identifying the individuals through the portable information appliance directly through biometric and/or other secret personal information, and by having the portable information appliance 301, 302 identify the user, a secure information and/or transaction system is realized. It will be observed that the identity of the user is kept in the possession and control of the individual and not broadcast throughout the network. In this way, individual privacy concerns can be implemented in that the act of using the portable information appliance 301, 302 for identification explicitly provides the individual's permission to perform identification activities.

It will be observed that this secure transaction system can be applied to any number of applications where privacy and security are concerns. For example, among telemedicine and telehealth implementation issues are those that address the protection and character of transactions between the patient and care-provider. These issues are important for patient-care-giver trust and, in some cases, may be subject to regulatory environments including the uniform reporting requirements of HIPAA. Because of the remote access character of telemedicine processes, technologies and processes are needed to positively identify and authenticate the patient and health-care individuals involved in telemedicine transactions.

The present invention can be used to positively identify remotely located individuals engaged in telemedicine/telehealth activities so as to assure patient-doctor confidential transactions. The authentication processes are used to prevent counterfeiting of the credentials of the patient or caregiver over remote distances while engaged in telemedicine. The identification process is to insure that the correct individuals are anonymously engaged in patient-care giver transactions and information sharing.

Each care provider and patient whose identity is to be secured and authenticated is issued a tamper destructive information appliance 302. Preferably, the information appliance is a portable device such as a smart card. The smart cards store biometric/personal information for identification, and can also contain pertinent health or medical information concerning the patient stored within one or more of the segments of the string stored by the information appliance 302. Further, because the smart card 302 identifies the user, the user maintains possession and control over their own identifying and personal information, and that information is not broadcasted over any network. This process also “verifies” that the remote transaction being conducted is with who is being represented and that the individual is not being tricked into providing information to someone not intended.

Having described the invention in detail and by reference to preferred embodiments thereof, it will be apparent that modifications and variations are possible without departing from the scope of the invention defined in the appended claims.

What is claimed is:

1. A method of storing information on an information appliance comprising:
forming a string having a plurality of delimited segments, wherein each of said plurality of delimited segments comprises:
a delimiter defining a known bit pattern; and
a segment containing information associated with applications that interact with said information appliance; and,
storing said string on said information appliance.

2. A method of storing information on an information appliance according to claim 1, wherein each delimiter comprises the same bit pattern.

3. A method of storing information on an information appliance according to claim 1, wherein each delimiter comprises a unique bit pattern.

4. A method of storing information on an information appliance according to claim 1, wherein each segment is encoded with a different encryption key using the same encryption algorithm.

5. A method of storing information on an information appliance according to claim 1, wherein each segment is encrypted by a unique encryption algorithm.

6. A method of storing information on an information appliance according to claim 1, wherein said segments are encrypted using a symmetric key such that the same key is used to encrypt and decrypt.

7. A method of storing information on an information appliance according to claim 1, wherein said segments are encoded using asymmetric encryption.

8. A method of storing information on an information appliance according to claim 1, wherein said segments are encrypted using a session key, and said session key is separately encrypted and stored on said information appliance.

9. A method of storing information on an information appliance according to claim 1, wherein a select one of said plurality of delimited segments is removed from said string by:
reading out said string;
locating said select one of said plurality of delimited segments;
removing said select one of said plurality of delimited segments from said string; and,
storing said string back to said information appliance.

10. A method of storing information on an information appliance according to claim 1, wherein a new segment is added to said string by:
accessing said new segment;
concatenating a new delimiter to said new segment to define a new delimited segment;
reading said string;
joining said new delimited segment to said string; and,
storing said string back to said information appliance.

11. A method of storing information on an information appliance comprising:
forming a string having a plurality of delimited segments, wherein each of said plurality of delimited segments comprises:
a delimiter defining a known bit pattern; and
a segment containing information associated with applications that interact with said information appliance; and,
encrypting said string; and,
storing said string on said information appliance.

12. A method of accessing information stored on an information appliance comprising:
accessing a string stored on said information appliance, said string comprising a plurality of delimited segments, each of said plurality of delimited segments having a delimiter and a segment, wherein each segment represents a unique information context;
identifying a predetermined delimiter associated with a predetermined segment;
detecting said predetermined delimiter within said string, said predetermined delimiter indicating the location within said string of said predetermined segment; and,
reading said predetermined segment.

13. A method of accessing information stored on an information appliance according to claim 12, wherein each delimiter comprises the same pattern of bits, and further comprising:
knowing prior to detecting, the relative position of said predetermined delimiter within said string; wherein said first predetermined delimiter is detected by reading sequentially through said string and detecting delimiters until said predetermined delimiter is located.

14. A method of accessing information stored on an information appliance according to claim 13, wherein said predetermined segment is read by:
determining the length of said predetermined segment; and,
reading said string by an amount based upon the determined length of said predetermined segment.

15. A method of accessing information stored on an information appliance according to claim 13, wherein said predetermined segment is read by:
reading a first portion of said string adjacent to said predetermined delimiter, said first portion comprising information concerning the length of said predetermined segment; and,
reading said string by an amount based upon the length of said predetermined segment read from said first portion.

16. A method of accessing information stored on an information appliance according to claim 13, wherein said predetermined segment is replaced back into said string at the same relative position from which said predetermined segment was read.

17. A method of accessing information stored on an information appliance according to claim 12, wherein:
each delimiter comprises a unique pattern of bits; and,
said predetermined delimiter is detected utilizing random access.

18. A method of accessing information stored on an information appliance according to claim 17, wherein said predetermined segment is replaced back into said string such that the sequence of said plurality of delimited segments after replacing said predetermined segment is different from the sequence of said plurality of delimited segments prior to removing said predetermined segment.

19. A method of accessing information stored on an information appliance according to claim 12, wherein said string is encrypted while stored on said information appliance such that each of said plurality of delimited segments are unintelligible, and further comprising decrypting said string such that said predetermined segment is decrypted and the remainder of said plurality of delimited segments remain unintelligible.

20. A method of accessing information stored on an information appliance according to claim 12, wherein:
said string is encrypted using a private key such that each segment of said plurality of delimited segments is stored on said information appliance as unintelligible information, and each segment can be decrypted using an associated public key, and further comprising:
decrypting said string using a select public key associated with said predetermined segment such that said predetermined segment is decrypted and the remainder of said plurality of delimited segments remain unintelligible.

21. A method of accessing information stored on an information appliance according to claim 12, wherein said predetermined segment is deleted from said information appliance by:
reading out said string entirely;
removing said predetermined delimiter and said predetermined segment from said string;
saving said string back to said information appliance.

22. A method of accessing information stored on an information appliance comprising:
selecting a predetermined delimiter, said predetermined delimiter identifying the location of a predetermined segment in a string stored on said information appliance, said string comprising a plurality of delimited segments;
locating said predetermined delimiter within said string;
extracting from said string, a first data portion, said first data portion comprising the length of said predetermined segment; and,
reading said predetermined segment from said string.

23. A method of accessing information stored on an information appliance according to claim 22, further comprising:
removing said predetermined segment, said first data portion, and said predetermined delimiter, from said string;
processing said predetermined segment;
determining a new length of said predetermined segment after being processed, and storing said new length in said first data portion;
reuniting said predetermined delimiter, said first data portion, and said predetermined segment with said string; and,
storing said string on said information appliance.

24. A method of accessing information stored on an information appliance according to claim 22, wherein said predetermined delimiter, said first data portion, and said predetermined segment are reunited with said string in the same relative positions from which were read.

25. A method of accessing information stored on an information appliance according to claim 22, wherein said predetermined delimiter, said first data portion, and said predetermined segment are reunited with said string by being appended to the end of said string.

26. A method of accessing information stored on an information appliance comprising:
selecting a predetermined delimiter, said predetermined delimiter identifying the location of a predetermined segment in a string stored on said information appliance, said string comprising a plurality of delimited segments;
locating said predetermined delimiter within said string;
extracting from said string, a first data portion, said first data portion
removing said predetermined segment, said first data portion, and said predetermined delimiter, from said string;
rejoining said string such that said string comprises said plurality of delimited segments except for said predetermined segment, said first data portion, and said predetermined delimiter;
saving said string back to said information appliance;
processing said predetermined segment;
determining a new length of said predetermined segment after being processed, and storing said new length in said first data portion;
reuniting said predetermined delimiter, said first data portion, and said predetermined segment with said string; and,
storing said string on said information appliance.

27. An information appliance comprising:
a string stored therein, said string comprising a plurality of delimited segments, each of said plurality of delimited segment comprising:
a delimiter comprised of a pattern of bits; and,
a segment comprising information or data unique to a predetermined application or function and wherein each of said plurality of segments is delimited by a segment identifier.

28. An information appliance according to claim 27, wherein each delimiter is unique.

29. An information appliance according to claim 27, wherein each delimiter is identical.

30. An information appliance according to claim 27, wherein each of said plurality of delimited segments further comprises a first data portion, said first data portion containing the length of the associated segment.

31. An information appliance according to claim 22, wherein at least one of said plurality of delimited segments contains biometric information sufficient to enable said information appliance to determine the identity of a user.

32. An information appliance according to claim 31, wherein said information appliance further comprises a program arranged to compare said biometric information against identification information entered by said user to verify the identity of said user.

33. An information appliance according to claim 32, wherein said information appliance is arranged to couple to a distributed productivity environment if the identity of said user is properly verified such that said user is logged into said distributed productivity environment anonymously.

34. An information appliance according to claim 27, wherein said string comprises an encrypted string stored on said information appliance such that a predetermined segment must be decrypted prior to use.

35. An information appliance according to claim 27, further comprising:
a first application arranged to read said string and modify the contents of said string by editing the contents of a select one of said plurality of delimited segments, removing a select one of said plurality of delimited segments from said string, or adding a new delimited segment to said plurality of delimited segments, wherein said string is written back to said information appliance after the contents are modified.

36. A method of providing authentication and identification across distributed productivity environments comprising:
coupling at least one information appliance to a network;
storing within said information appliance, personal information sufficient to determine the identity of a user of said information appliance;
obtaining identification information from said user;
comparing said identification information provided by said user against said personal information stored within said information appliance;
allowing access to said distributed productivity environment if said personal information matches said identification information; and,
restricting access to said distributed productivity environment if said personal information does not match said identification information.

37. A method of providing authentication and identification across distributed productivity environments according to claim 36, wherein said personal information comprises a passcode stored within said information appliance.

38. A method of providing authentication and identification across distributed productivity environments according to claim 36, wherein said personal information comprises biometric information, wherein said identification information is obtained from said user utilizing a biometric reading device.

39. A method of providing authentication and identification across distributed productivity environments according to claim 36, wherein said information appliance comprises a string of delimited segments, each of said delimited segments containing information associated with a unique application supported by said information appliance.

40. A method of providing authentication and identification across distributed productivity environments according to claim 36, wherein said personal information is compared to said identification information within said information appliance, such that personal information is not broadcast across said distributed productivity environment.

41. A method of providing authentication and identification across distributed productivity environments according to claim 40, wherein said information appliance couples said user to said distributed productivity environment anonymously when access to said distributed productivity environment is allowed.

42. A method of providing authentication and identification across distributed productivity environments according to claim 40, wherein said personal information is stored within said information appliance as encrypted information, and further comprising decrypting said personal information prior to comparing said personal information to said identification information.
